(19) United States
(12) Patent Application Publication
(10) Pub. No.: US 2011/0039468 A1
(43) Pub. Date: Feb. 17, 2011

(54) PROTECTIVE APPAREL HAVING BREATHABLE FILM LAYER

(76) Inventors: Alfred Frank Baldwin, JR., Greenboro, NC (US); Bradley P. Finnigan, Greensboro, NC (US); Yuhming Chen, Pittsford, NY (US)

Correspondence Address: MYERS BIGEL SIBLEY & SAJOVEC, PO BOX 37428, RALEIGH, NC, 27627, US

(21) Appl. No.: 12/539,662

(22) Filed: Aug. 12, 2009

(51) Int. Cl. B32B 5/26; B32B 5/24; B32B 27/36; B32B 27/12; B32B 27/32

(52) U.S. Cl. 442/381; 442/327; 442/395; 442/394; 442/398

(57) ABSTRACT

The present invention provides a laminate for protective apparel. In one embodiment, the laminate includes at least one nonwoven layer and a breathable film layer bonded to the nonwoven layer. The breathable film layer includes first and second microporous film layers and an internal monolithic (non-porous) layer positioned between the first and second microporous film layers.

### FIELD OF THE INVENTION

The present invention relates to protective apparel having improved breathability and viral barrier properties.

### BACKGROUND OF THE INVENTION

Hospital gowns, particularly surgical gowns in operating and emergency rooms, are exposed to a variety of liquids which the wearer does not want to contact the wearer's skin. Of significant concern is exposure to body fluids such as blood. Body fluids can permeate through the gown permitting pathogens (e.g., bacteria and viruses) to come in contact with the skin of a wearer.

On Dec. 6, 1991, OSHA published Final Rule (29 CFR Part 1910.1030, on protecting healthcare workers from occupational exposure to bloodborne pathogens. This final rule states When there is occupational exposure, the employer shall provide at no cost to the employee, appropriate personal protective equipment such as, but not limited to, gloves, gowns, laboratory coats, face shields or masks, and eye protection, and mouthpieces, resuscitation bags, pocket masks, or other ventilation devices. Personal protective equipment will be considered appropriate only if it does not permit blood or other potentially infectious materials to pass through to or reach the employee's work clothes, street clothes, undergarments, skin, eyes, mouth, or other mucous membranes under normal conditions of use and for the duration of time which the protective equipment will be used.” In the hospital environment, of particular concern are the human immunodeficiency virus and hepatitis virus. Thus, liquid repellency is recognized as an essential property in protective apparel used in hospitals. In 2003 the Association for the Advancement of Medical Instrumentation (AAMI) issued a directive for the use of protective gowns in surgical situations. In this document, entitled “Selection and Use of Surgical Gowns and Drapes in Health Care Facilities” the types of surgical gowns were determined for four levels, 1 through 4. For the most severe challenge of fluid and possible transmission of disease, level 4 gowns are recommended. Level four gowns must be made from material that passes both ASTM F-1670:2003, and F-1671:2003. These tests measure the materials resistance to penetration by liquid, at the typical surface tension of blood, and by liquid borne viral penetration. Thus there is a need to deliver such performance.

Another desirable performance attribute is the resistance to very low surface tension fluids commonly used as disinfectants in the hospital setting. Solutions containing isopropyl alcohol are of specific interest. Disinfectant mixtures with surfactant, antimicrobial, and up to 80% isopropanol are encountered much more frequently as they replace the mostly water borne disinfectants of the past. One way of preventing these solutions from penetrating is to add fluorochemical oil repellent to the product. Examples of this approach are described in U.S. Pat. No. 7,381,666 wherein a fluorochemical repellent is added to the melt of the polymer to achieve solvent penetration resistance. Another example is U.S. Pat. No. 5,981,038. wherein fluorochemical oil and water repellent is incorporated into the product. A disadvantage of this approach is that the surfaces of the film layer become low in surface energy and are difficult to adhere to with adhesive or thermal type bonding. In the case of this invention, the penetration of low surface tension liquids, oils, fats, and solvents is prevented by the breathable barrier layer within the film. This approach allows the film to have higher surface energy surfaces, which facilitates thermal, ultrasonic and adhesive bonding. One way of determining the resistance to isopropanol solutions is to prepare a 70% isopropanol/30% water solution containing 0.1% Sevron Red dye, and apply 0.9 cc of the solution to the surface of the laminate. The laminate is placed over a white blotter paper or filter paper. A weight is applied such that 1 psi of pressure is applied to the liquid challenge and left in place for 3 minutes. Following that exposure the white blotter paper is inspected for penetration which is indicated by a dye stain. The stain is rated 1 through 6, with (1), being none or trace amounts of color, and (6) being completely stained solid. This test is referred to as the “PPT” or Pressure Penetration Test.

The gowns, besides being impervious to liquids and pathogens, must be comfortable. A key aspect of comfort is breathability. In general, impervious materials do not transmit moisture vapor. As a result, water vapor from perspiration is not transmitted from the inside to the outside of the gown, and natural evaporative cooling does not occur. Ideally, in a continuous film of a hydrophilic material, water vapor is effectively transported through the film on a molecule by molecule basis. The measurement of the rate of this is referred to as moisture vapor transmission rate (“MVTR”).

One solution to the above characteristics is a laminate having a microporous structure and is proposed in U.S. Pat. Nos. 4,433,026 and 5,027,438. U.S. Pat. No. 4,443,511 proposes a layered waterproof, breathable and stretchable article for use in protective articles. The preferred stretchable polymer material is polytetrafluoroethylene. U.S. Pat. No. 4,867,881 proposes an oriented microporous film formed by liquid-liquid phase separation of a crystalline thermoplastic polymer and a compatible liquid. U.S. Pat. Nos. 5,409,761 and 5,560,974 propose a non-woven composite fabric bonded to a thermoplastic microporous film.

U.S. Pat. No. 6,410,465 proposes a fibrous nonwoven comprising first and second nonwoven webs bonded together and bonded to a moisture vapor permeable thermoplastic film using a powder adhesive. The powder adhesive is used for each layer and the webs have different compatibility characteristics with the powder adhesive.

EP 1 034 075 B1 discusses combining microporous and monolithic breathable polymers in a multi-layer film, however, the reference does not teach the inclusion of the adhesive bonding agent in the film layers. It also does not teach the viral barrier performance of the laminate, or the barrier to organic materials such as isopropanol. Without the proper incorporation of the bonding agent into the film, the film delaminates by simple mechanical action such as that encountered in gown manufacturing processes, and importantly, the film delaminates when in contact with organic solvents such as isopropanol. The delamination of the film layers may cause the protective article to lose barrier properties due to holes and tears forming in the monolithic layer. Thus a need remains for a laminate for protective apparel that is impervious to liquids and pathogens and is breathable. Barrier properties can also be lost due to the ability of fluids to bypass the barrier layer of the delaminated protective article at exposed edges, such as those encountered at the bottom of a surgical gown.

### SUMMARY OF THE INVENTION

Accordingly, the present invention provides a laminate for protective apparel. In one embodiment the laminate comprises at least one nonwoven layer and a breathable film layer bonded to the nonwoven layer. The breathable film layer comprises first and second microporous film layers and an internal monolithic (non-porous) layer positioned between the first and second microporous film layers.

In another embodiment, the laminate comprises a first nonwoven layer, a second nonwoven layer and a breathable film layer positioned between the first and second nonwoven layer. The breathable film layer comprises first and second microporous film layers and monolithic (non-porous) layer positioned internally between the first and second microporous film layers.

In another embodiment, the laminate comprises a first nonwoven layer, and a second nonwoven layer, and a breathable film layer positioned between the first and second nonwoven layer. The breathable film may comprise multiple microporous layers with multiple layers of monolithic film layered in sequence with the microporous layers comprising the top and bottom layer with the monolithic layers alternating with microporous layers in the internal structure of the film. For example, if the microporous layer is designated ‘A’, and the monolithic layer is designated ‘B’, then an exemplary film may include ‘A-B-A’, or A-B-A-B-A, or A-A-B-A-A, or A-B-A-B-A-B-A, and so on.

In another embodiment, the laminate is provided in the form of an article of protective clothing or garment.

### DETAILED DESCRIPTION OF THE INVENTION

The present invention now is described more fully hereinafter in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

All publications, patent applications, patents, and other references mentioned herein are incorporated herein by reference in their entireties.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that, although the terms “first”, “second”, etc. may be used herein to describe various elements, components, regions, layers and/or sections, these elements, components, regions, layers and/or sections should not be limited by these terms. These terms are only used to distinguish one element; component, region, layer or section from another element, component, region, layer or section. Thus, a “first” element, component, region, layer or section discussed below could also be termed a “second” element, component, region, layer or section without departing from the teachings of the present invention.

In one aspect the present invention relates to a laminate that has improved breathability, is impervious to liquids, and is impervious to pathogens. The laminate comprises at least one nonwoven layer and a breathable film layer bonded to the nonwoven layer. The breathable film layer comprises first and second microporous film layers and a monolithic (non-porous) layer positioned between the first and second microporous film layers.

As used herein, the term “laminate” relates to a structure having two or more layers. Such a composite material may also be referred to as a “barrier material.” The laminate or barrier material may be used in apparel, especially protective apparel, such as surgical or emergency room gowns where liquid and pathogen blockage are important. Such protective garments include gowns, coveralls, gloves, arm shields, hoods, boots, aprons, finger cots and the like.

As used herein, the terms “liquid impervious” and “pathogen impervious” relate to the laminate being a barrier to various liquids, particularly body fluids or liquids potentially bearing bacterial and viral pathogens. Exemplary liquids include blood, water, oil, alcohol, and mixtures thereof. Exemplary bacterial and viral pathogens include hepatitis B virus, hepatitis C virus, human immunodeficiency virus and PhiX174 bacteriophage. Preferably the laminate can prevent passage of any virus of greater than 25 nm from penetrating through the laminate. Inasmuch as bacteria are substantially greater in size than virus, various bacteria will also be prevented from passage.

As used herein, the term “breathable” relates to the overall laminate being able to transfer moisture vapor resulting from perspiration through the article at a rate sufficient to maintain the skin of the wearer in a reasonably dry state during normal conditions. This rate is measured as MVTR.

As used herein, the term “monolithic” relates to a structure that is substantially solid, continuous, sheet-like, non-permeable and contains substantially no holes or cracks, i.e., is non-porous.

The at least one nonwoven layer can be a wide variety on nonwoven fabric constructions. Exemplary nonwoven fabrics may include, but are not limited to, spunbond fabrics, meltblown fabrics, flash spun fabrics, spunlaced fabrics, spunbond-meltblown-spunbond fabrics, and combinations thereof.

Spunbonded fabrics are described in U.S. Pat. No. 4,340,563, U.S. Pat. No. 3,692,618, U.S. Pat. No. 3,802,817, U.S. Pat. No. 3,338,992, and U.S. Pat. No. 5,643,653. Spunbond fabrics conventionally contain fibers greater than about ten microns (10p) in diameter and conventionally are made from thermoplastic polymers such as polyolefins, polyamides, or polyesters.

Meltblown fibers and meltblown fabrics conventionally are produced by extruding thermoplastic polymer through a fine orifice and subsequently exposing the polymer stream to a jet of high velocity air. Meltblown fibers conventionally are less than about ten microns (10μ) in diameter. Meltblown fibers and fabrics are described in U.S. Pat. No. 3,849,241, U.S. Pat. No. 4,307,143, and U.S. Pat. No. 4,663,220.

Another fabric conventionally used in barrier applications, and which may be finished in accordance with embodiments of the present invention, is Tyvek® brand plexifilimentary flash spun polyethylene from DuPont. Fabrics of this type are disclosed in U.S. Pat. No. 3,081,519.

Another fabric which may be used in accordance with embodiments of the present invention, is Evolon® brand spunbond/spunlaced fabric. This fabric is composed of splittable filaments that, when split in the spunlace process, result in fine fibers with good barrier properties. For example, U.S. Pat. Nos. 5,899,785 and 5,970,583, describe a nonwoven lap of very fine continuous filament and the process for making such nonwoven lap using traditional nonwoven manufacturing techniques. The raw material for this process is a spun-bonded composite, or multi-component fiber that is splittable along its length by mechanical or chemical action. As an example, after a nonwoven lap is formed, it may be subjected to high-pressure water jets which cause the composite fibers to partially separate along their length and become entangled with one another thereby imparting strength and microfiber-like softness to the final product.

Another nonwoven fabric is a polyethylene or polypropylene spunbond-meltdown-spunbond (SMS) fabric. SMS fabric is a thermal bonded composite of three nonwoven layers; a top layer of spunbond, a middle layer of meltblown fiber, and a bottom layer of spunbond. Exemplary SMS fabrics are described in U.S. Pat. No. 5,885,909.

It is to be recognized that the nonwoven layer could be replaced by a woven, knit, paper or netting layer so long as such layer is compatible with the breathable film layer and provides support and protection therefor while being liquid impervious and pathogen impervious.

The nonwoven layer may also be pretreated with property modifiers known in the art for whatever specific end use requirements are needed. Such modifiers include, but are not limited to, flame retardants, water repellants, antimicrobial agents, softeners and antistatic agents.

The breathable film layer typically comprises first and second microporous film layers with a monolithic layer positioned between the microporous layers. The encasing or sandwiching of the breathable layer protects this layer from mechanical damage or thermal damage, and allows for bonding (e.g., ultrasonic or thermal) at substantially low thicknesses. The microporous film layer is preferably a thermoplastic polymer selected from the group including but not limited to: linear-low density polyethylene, low density polyethylene, polyethylene, ethylene copolymers, polypropylene, polypropylene copolymers, propylene-ethylene copolymers, metallocene catalyzed polyolefins, ethylene vinyl acetate copolymers, or block copolymers based on styrene and butadiene, or triblock copolymers based on styrene and ethylene/butylene. The microporous film layer may also be formed from combinations, blends, and derivatives of the abovementioned polymers.

In yet another embodiment, the first and second microporous layers can comprise a first unmodified layer (e.g., polyethylene) and a second modified layer (e.g., polyethylene) with the modified layers in contact with the monolithic layers. The modified microporous layer may be modified by addition of an acrylate copolymer compatibilizer such as the copolymer of ethylene and methyl acrylate (EMA). Acid/acrylate modified ethylene vinyl acetate polymers, such as Bynel® 3101 from DuPont, are also suitable compatibilizers to improve the adhesion between the microporous layers and monolithic layer.

The monolithic layer is preferably a thermoplastic layer or film. The layer may be a continuous unbroken barrier layer. It may have a basis weight of 1.0 to 5.0 grams/sq. meter. The monolithic layer may be hygroscopic and include or is blended with an adhesive. Suitable thermoplastic resins for preparing these films include polyolefins, polyesters, polyetheresters, polyamides, polyether amides, ionomers, and urethanes. Examples of suitable thermoplastic polymers include, by way of illustration only, such polyolefins as polyethylene, polypropylene, poly(1-butene), poly(2-butene), poly(1-pentene), poly(2-pentene), poly (3-methyl- 1-pentene), poly (4-methyl-1-pentene), 1,2-poly-1,3-butadiene, 1,4-poly-1,3-butadiene, polyisoprene, polychloroprene, polyacrylonitrile, poly(vinyl acetate), poly(vinylidene chloride), polystyrene, and the like; such polyesters as poly(ethylene terephthalate), poly(butylenes)terephthalate, poly(tetramethylene terephthalate), poly(cyclohexylene-1,4-dimethylene terephthalate) or poly(oxymethylene-1,4-cyclohexylenemethyleneoxyterephthaloyl), and the like; such polyetheresters as poly(oxyethylene)-poly(butylene terephthalate), poly(oxytetramethylene)-poly(ethylene terephthalate), and the like; and such polyamides as poly(6-aminocaproic acid) or poly(caprolactam), poly(hexamethylene adipamide), poly(hexamethylene sebacamide), poly(11-aminoundecanoic acid), and the like. In one embodiment, the film layer is comprised of a block polyether copolymer such as a block polyetherester copolymer, a polyetheramide copolymer, a polyurethane copolymer, a poly(etherimide) ester copolymer, polyvinyl alcohols, or a combination thereof. Preferred copolyether ester block copolymers are segmented elastomers having soft polyether segments and hard polyester segments, as disclosed in U.S. Pat. No. 4,739,012. Suitable copolyether ester block copolymers are sold by DuPont under the name Hytrel®. Suitable copolyether amide polymers are copolyamides available under the name Pebax® from Atochem Inc. of Glen Rock, N.J., USA. Suitable polyurethanes are thermoplastic urethanes available under the name Estane® from the B.F. Goodrich Company of Cleveland, Ohio, USA. Suitable copoly(etherimide) esters are described U.S. Pat. No. 4,868,062.

In one embodiment the laminate may comprise more than three layers. Suitable examples, but are not limited to, laminate structures wherein A and C are outer microporous layers and B is an internal monolithic layer, are:

A-B-A

A-A-B-A

A-B-A-A

A-A-B-A-A

A-B-A-A-A

A-B-A-B-A

A-B-A-A-A-A-A

A-A-B-A-A-A-A

A-A-A-B-A-A-A

A-B-A-A-A-B-A

A-B-A-A-B-A-A

A-B-A-B-A-A-A

A-B-A-B-A-B-A

A-B-A-A-A-A-A-A

A-A-B-A-A-A-A-A

A-A-A-B-A-A-A-A, and

A-B-A-A-A-A-B-A.

It should be understood that the multiple “A” breathable layers in each of the example structures above can be the same or different kind of microporous layer. Further, it is contemplated that each “A” breathable layer in the above structures could comprise two or more breathable layers in order to better control other film properties, such as the ability to bond to nonwovens. For example, when there are two breathable layers in one “A” breathable layer in the above structures, some exemplary film structures can be shown as follows, where C is the second breathable layer:

A-C-B-C-A

A-C-A-C-B-C-A

A-C-B-C-A-C-A

A-C-A-C-B-C-A-C-A

A-C-B-C-A-C-A-C-A, and

A-C-B-C-A-B-C-A

as described in U.S. Patent Application No. [Attorney Docket No. 20541US01 filed Aug. 12, 2009 by Pliant Corporation.]

The laminate of the invention may have a MVTR moisture vapor transmission rate of at least 700 g/sq.meter/24 hr, per INDA, STM 70.4 (ASTM F-1249). using a MOCON, Permatran W; model 100K permeability tester. More preferably the MVTR exceeds 2000 g/sq.meter/24 hr, and more preferably exceeds 3000 g/sq. meter/24 hours. The laminate may pass ASTM F-1671. The laminate may exhibit resistance to 70% isopropanol under 1 psi for 3 minutes.

The film will also provide a laminate having a sufficient strength for the intended end use. For example, if used in a garment the resulting laminate preferably has a grab tensile strength in the cross-machine direction of at least about 10 pounds, or preferably at least about 15 pounds, as defined in ASTM D1117.7. Preferably, the grab tensile strength is in the range of about 8 to 40 pounds.

The resulting laminate may preferably exhibits an electrostatic decay time of less than about 20 seconds, less than about 10 seconds, often less than about 5 seconds, more often less than about 1 second and still more often less than about 0.5 seconds at 50% relative humidity as defined by NFPA-99.

The microporous layer and/or monolithic layer may include additives and modifying agents known in the art. Examples include coloring agents, plasticizers, fillers, binders, pigments, antioxidants, stabilizers, antistatic agents, fillers (e.g., talc, silica, clay, and the like), and elastomers. Incorporation of antibacterial or antiviral agents, coagulants such as gelatin or collagen, may be added to enhance the barrier to pathogens.

The resulting breathable film laminate may be stretched using techniques such as machine direction stretching, trans machine stretching, simultaneous or sequential biaxial stretching, stretching on interdigitating rolls and the like. Stretching may also be accomplished by making the film by the blown film process wherein the film is stretched in all directions by the pressure inside the bubble. The stretching opens micropores in the olefinic layer while thinning and stretching the monolithic layer.

An adhesive may be applied to the film or fabric by numerous methods such as rotogravure, spray, screen printing, scatter coating, or a positive displacement coating. Spray or coating is the most preferred for adhesive add-on control.

The method of thermally-activated adhesive application should preferably allow for discontinuous coating of the adhesive across the breathable layer and/or the fibrous layer to maintain the MVTR of the composite barrier material. Typical adhesive add-on levels for an acceptable bond, ranges from about 1 to about 12 grams/sq. meter. The type of adhesive and application method should preferably achieve an acceptable bond between the breathable layer and the fibrous layer with a minimum amount of adhesive. The adhesive, breathable layer, and the fibrous layer fabric support are preferably stable to commercial methods of sterilization, such as gamma irradiation and ethylene oxide and should preferably not exhibit strong or offensive odors after sterilization. The adhesive should preferably not cause a loss of MVTR after lamination.

The breathable layer and the at least one nonwoven layer can be joined or bonded together by various thermal bonding techniques including hot calendaring, ultrasonic bonding, point bonding, hot air techniques, radiant heating, infrared heating and the like.

Alternatively, the adhesive or bonding agent can be incorporated into the fibers of the nonwoven layer to aid in the lamination of the nonwoven layer to the breathable layer. In one embodiment, two different thermally-activated adhesive materials can be used, i.e., a first thermally-activated adhesive and a second thermally-activated adhesive material can be selected. It is important that the temperature used to bond the two layers together be less than the melting point of the constituents of the breathable layer or nonwoven layer in order to maintain the integrity of the breathable layer or nonwoven layer, thereby reducing the risk of forming pinholes and losing strength during the laminating process. Thus it is important to the present invention that the breathable layer or nonwoven layer in its entirety not be allowed to reach its overall melting point and thereby compromise the integrity and barrier properties of the resulting article. In one embodiment, the melting point of the thermally-activated adhesive material is at least 10° F. less, preferably at least 25° F. less and more preferably at least 50° F. less than the lower of the melting points of the constituents of the nonwoven layer and the breathable layer.

By “localizing” heat bonding via the bonding additive and/or a discrete bond pattern, a means is provided to secure attachment with minimal damage to the breathable film layer while at the same time maintaining good flexural characteristics with respect to the overall laminate. Additionally, such a bond pattern may be in a shape or pattern, i.e., a logo or fabric pattern, to provide improved aesthetics to the laminate (garment).

Exemplary adhesive materials include polyamides, ethylene copolymers such as ethylene vinyl acetate (EVA), ethylene ethyl acrylate (EEA), ethylene acrylic acid (EAA), ethylene methyl acrylate (EMA) and ethylene normal-butyl acrylate (ENBA), wood resin and its derivatives, hydrocarbon resins, polyterpene resins, atactic polypropylene and amorphous polypropylene. Also included are predominately amorphous ethylene propylene copolymers commonly known as ethylene-propylene rubber (EPR) and a class of materials referred to as toughened polypropylene (TPP) and olefinic thermoplastic polymers where EPR is mechanically dispersed or molecularly dispersed via in-reactor multistage polymerization in polypropylene or polypropylene/polyethylene blends.

An exemplary adhesive is Rextac® RT 2215 amorphous polyalphaolefin (APAO) adhesive available from Huntsman. Other exemplary adhesives include Vestoplast® 608 amorphous polyalphaolefin (APAO) adhesive available from Evonik, and powder adhesives such as polyester and polyamide based adhesives like Grillex 9, Grillex D1365E or Grillex 1531E available from EMS.

The following example will serve to further exemplify the nature of the invention but should not be construed as a limitation on the scope thereof, which is defined by the appended claims.

### Example

A three-layer laminate material comprising a multilayer, breathable, fluid-impervious film sandwiched between two layers of nonwoven SMS polypropylene is formed. The multilayer, breathable, fluid-impervious film layer, having a basis weight of 25 gsm, was manufactured by Pliant Corporation, IL and consisted of monolithic and microporous layers. The nonwoven SMS polypropylene material had a basis weight of 18 gsm and was supplied by First Quality Nonwovens, Inc., PA. The film and nonwoven layers were adhesively bonded together using approximately 3 gsm of Huntsman Rextac® RT 2215 Amorphous Polyalphaolefin (APAO) adhesive. Material compositions are provided in the following tables:

3-layer laminate material

| | | Basis |
|---|---|---|
| Layer | Material | Weight |
| Layer 1 | Polypropylene SMS | 18 gsm |
| Layer 2 | Hybrid Film | 25 gsm |
| Layer 3 | Polypropylene SMS | 18 gsm |

Hybrid Film Composition

| | | Basis |
|---|---|---|
| Layer | Material | Weight |
| Layer 1 | Microporous Polyethylene (PE) | 5.7 gsm |
| Layer 2 | Microporous PE w/EMA Compatibilizer | 5.6 gsm |
| Layer 3 | Monolithic DuPont Hytrel ® 8206 w/EMA Compatibilizer | 2.4 gsm |
| Layer 4 | Microporous PE w/EMA Compatibilizer | 5.6 gsm |
| Layer 5 | Microporous Polyethylene (PE) | 5.7 gsm |

(EMA—copolymer of ethylene and methyl acrylate)

The laminate material was tested in accordance with standard test methods and the results are shown in the following table:

3-layer laminate results

| Property | Units | Laminate |
|---|---|---|
| Basis Weight | osy | 1.9 |
| MD Trap Tear | lb | 5.2 |
| XD Grab Tensile | lb | 15.6 |
| MD Handleometer | g | 91 |
| XD Handleometer | g | 37.0 |
| Martindale | mg | 4.9 |
| MVTR | g/m2/day | 2500 |
| Hydro Head | cm | 181 |
| PPT * | rating (1-6) | 1 |
| ASTM F1670 | P/F | Pass |
| ASTM F1671 | P/F | Pass |

* Internal test method for determining the Pressure Penetration of simulated alcohol based disinfectant through a fabric (PPT)

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. A laminate for protective apparel being liquid impervious and pathogen impervious, the laminate comprising:
at least one nonwoven layer;
a breathable film layer bonded to the nonwoven layer and comprising first and second microporous film layers and a monolithic layer positioned between the first and second microporous film layers.

2. The laminate according to claim 1, wherein the monolithic layer of the breathable film layer comprises copolyether ester, copolyether amide or urethane polymer.

3. The laminate according to claim 1, wherein the monolithic layer of the breathable film layer has a basis weight of 1.0 to 5.0 grams/sq. meter.

4. The laminate according to claim 1, wherein the monolithic layer is a thermoplastic layer or film and is a continuous unbroken barrier layer.

5. The laminate according to claim 1, wherein the first and second microporous film layers of the breathable film layer comprises polyethylene or polypropylene.

6. The laminate according to claim 1, wherein the breathable film layer has a thickness of 20 to 25 μm.

7. The laminate according to claim 1, wherein the breathable film layer has an INDA STM 70.4-99, and a MVTR of at least 700 grams/sq meter/24 hrs.

8. The laminate according to claim 1 that passes ASTM F-1671.

9. The laminate according to claim 1 that exhibits resistance to 70% isopropanol under 1 psi for 3 minutes.

10. A laminate for protective apparel being liquid impervious and pathogen impervious, the laminate comprising:
a first nonwoven layer;
a second nonwoven layer;
a breathable film layer positioned between the first and second nonwoven layers and comprising first and second microporous film layers and a monolithic layer positioned between the first and second microporous film layers.

11. The laminate according to claim 10, wherein the breathable film layer is bonded to at least one of the first or second nonwoven layers via thermal bonding, adhesive bonding or ultrasonic bonding or a combination thereof.

12. The laminate according to claim 10, wherein the monolithic layer of the breathable film layer has a basis weight of 1.0 to 5.0 grams/sq. meter.

13. The laminate according to claim 10, wherein the monolithic layer is a thermoplastic layer or film and is a continuous unbroken barrier layer.

14. The laminate according to claim 10, wherein the first and second microporous film layers of the breathable film layer comprises microporous polyethylene or microporous polypropylene.

15. The laminate according to claim 10, wherein the breathable film layer has a thickness of 20 to 25 μm.

16. The laminate according to claim 10, wherein the breathable film layer has an INDA STM 70.4-99, and a MVTR of at least 700 grams/sq meter/24 hrs.

17. The laminate according to claim 10 that passes ASTM F-1671

18. The laminate according to claim 10 that exhibits resistance to 70% isopropanol under 1 psi for 3 minutes.
